(19) United States
(12) Patent Application Publication
(10) Pub. No.: US 2022/0111951 A1
(43) Pub. Date: Apr. 14, 2022

(54) AIR ACCELERATION AT LEADING EDGE OF WING

(71) Applicant: The Boeing Company, Chicago, IL (US)

(72) Inventors: Arvin Shmilovich, Huntington Beach, CA (US); John Alexander Ziebart, Bellevue, WA (US); Daniel H. Gally, Mukilteo, WA (US)

(21) Appl. No.: 17/378,532

(22) Filed: Jul. 16, 2021

Related U.S. Application Data
(60) Provisional application No. 63/089,164, filed on Oct. 8, 2020.

(51) Int. Cl. B64C 21/04; B64C 9/24; B64D 13/00; B64D 15/04

(52) U.S. Cl. CPC B64C 21/04; B64D 15/04; B64D 13/00; B64C 9/24

(57) ABSTRACT

Air acceleration at leading edge of aircraft wing. In one embodiment, a slat disposed along a leading edge of a wing of an aircraft. The slat includes a skin structure having an aerodynamic shape, and a hollow space within the skin structure. The slat further includes a nozzle disposed on the skin structure to accelerate air collected in the hollow space into an external environment outside the slat to increase lift and reduce drag for the wing.

### RELATED APPLICATIONS

This non-provisional patent application claims priority to U.S. Provisional Patent Application No. 63/089,164 filed on Oct. 8, 2020, which is incorporated by reference as if fully provided herein.

### FIELD

This disclosure relates to the field of aircraft, and more particularly, to aircraft wing lift and drag performance.

### BACKGROUND

The wing of an aircraft may include a slat along its leading edge for improved flight control. In particular, a slat can deploy forward from the leading edge of the wing for increased lift at relatively lower speeds during takeoff or landing. When the aircraft is in cruise, the slat is stowed back against the wing leading edge for speed and fuel efficiency. Aircraft manufacturers continue to seek wing/slat arrangements that provide increased lift-to-drag ratio for improved aircraft takeoff performance.

### SUMMARY

Provided herein are systems and method for air acceleration at the leading edge of a wing. One or more nozzles are disposed at the leading edge of the wing, or slat, to improve aircraft takeoff performance. In particular, the nozzle accelerates air from an internal area of the leading edge to the external environment in front of the leading edge for increased lift and reduced drag. The internal area at the wing leading edge, or slat, may receive air from an air supply of an existing system of the aircraft, and may advantageously make use of air that would otherwise be waste. The air ejected into the ambient flow helps alter the flow pattern over the wing, resulting in higher lift and lower drag. Consequently, the improvement in the lift-to-drag ratio enables higher load carrying capacity, shorter runway lengths, and longer range.

One embodiment comprises a slat disposed along a leading edge of a wing of an aircraft. The slat includes a skin structure having an aerodynamic shape, and a hollow space within the skin structure. The slat further includes a nozzle disposed on the skin structure to accelerate air collected in the hollow space into an external environment outside the slat to increase lift and reduce drag for the wing.

Another embodiment is an aircraft. The aircraft includes a wing with a leading edge; and a slat mounted at the leading edge of the wing. At least one of the wing and the slat includes a nozzle to accelerate air collected inside the at least one of the wing and the slat to an external environment of the aircraft to increase lift and reduce drag for the wing.

Yet another embodiment is a method of improving aerodynamic airflow for a wing of an aircraft. The method includes transporting air from an air supply source of the aircraft to a hollow space within a slat of the wing. The method further includes ejecting the air collected in the hollow space with a nozzle to an external environment in front of the leading edge of the wing.

The features, functions, and advantages that have been discussed can be achieved independently in various embodiments or may be combined in yet other embodiments, further details of which can be seen with reference to the following description and drawings.

### DESCRIPTION OF THE DRAWINGS

Some embodiments of the present invention are now described, by way of example only, with reference to the accompanying drawings. The same reference number represents the same element or the same type of element on all drawings.

FIG. 1 is a perspective view of an aircraft.

FIG. 2A is a side view of wing in a retracted position.

FIG. 2B is a side view of wing in a deployed position.

FIG. 3 is a cross-sectional side view of slat.

FIG. 4 is a cross-sectional side view of a slat in an illustrative embodiment.

FIG. 5A is a cross-sectional side view of slat with nozzle at aft surface of slat in an illustrative embodiment.

FIG. 5B is a cross-sectional side view of slat with nozzle at aft surface of slat in another illustrative embodiment.

FIG. 6A is a cross-sectional side view of slat with nozzle at lower lip in an illustrative embodiment.

FIG. 6B is a cross-sectional side view of slat with nozzle at lower lip in another illustrative embodiment.

FIG. 7A is a cross-sectional side view of slat with nozzle at lower lip in yet another illustrative embodiment.

FIG. 7B is a cross-sectional side view of slat with multiple air ejection sources in an illustrative embodiment.

FIG. 8A is a cross-sectional side view of a wing leading edge in an illustrative embodiment.

FIG. 8B is a cross-sectional side view of wing leading edge in another illustrative embodiment.

FIG. 9A is a cross-sectional side view of wing leading edge in a further illustrative embodiment.

FIG. 9B is a cross-sectional side view of wing leading edge in yet a further illustrative embodiment.

FIG. 10 is a perspective view of a wing leading edge in an illustrative embodiment.

FIG. 11 is a block diagram of an aircraft in an illustrative embodiment.

FIG. 12 is a flow chart illustrating a method of improving aerodynamic airflow for an aircraft in an illustrative embodiment.

### DETAILED DESCRIPTION

The figures and the following description illustrate specific exemplary embodiments. It will be appreciated that those skilled in the art will be able to devise various arrangements that, although not explicitly described or shown herein, embody the principles described herein and are included within the contemplated scope of the claims that follow this description. Furthermore, any examples described herein are intended to aid in understanding the principles of the disclosure, and are to be construed as being without limitation. As a result, this disclosure is not limited to the specific embodiments or examples described below, but by the claims and their equivalents.

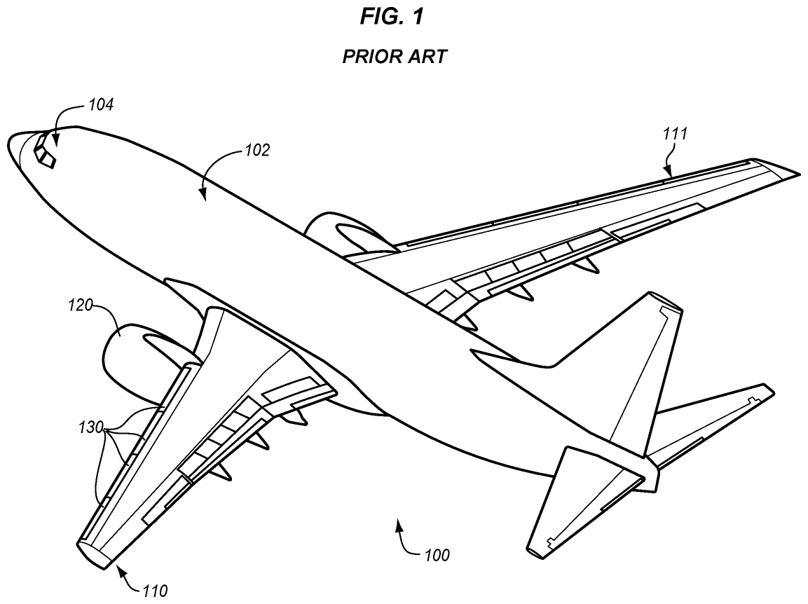

FIG. 1 is a perspective view of an aircraft 100. Aircraft 100 includes fuselage 102, which comprises the main body of aircraft 100. Cockpit 104 is situated at the nose or front of fuselage 102 and houses the pilot that controls flight of aircraft 100. A pair of wings 110-111 project outward from fuselage 102 to provide lift for aircraft 100, and one or more engines 120 provide thrust. Aircraft 100 further includes various flight control surfaces to control the position and speed of aircraft 100. In particular, each wing 110-111 may include one or more slats 130 along the wing leading edge which extend forward to provide increased lift for aircraft 100 during low-speed operations such as takeoff and landing.

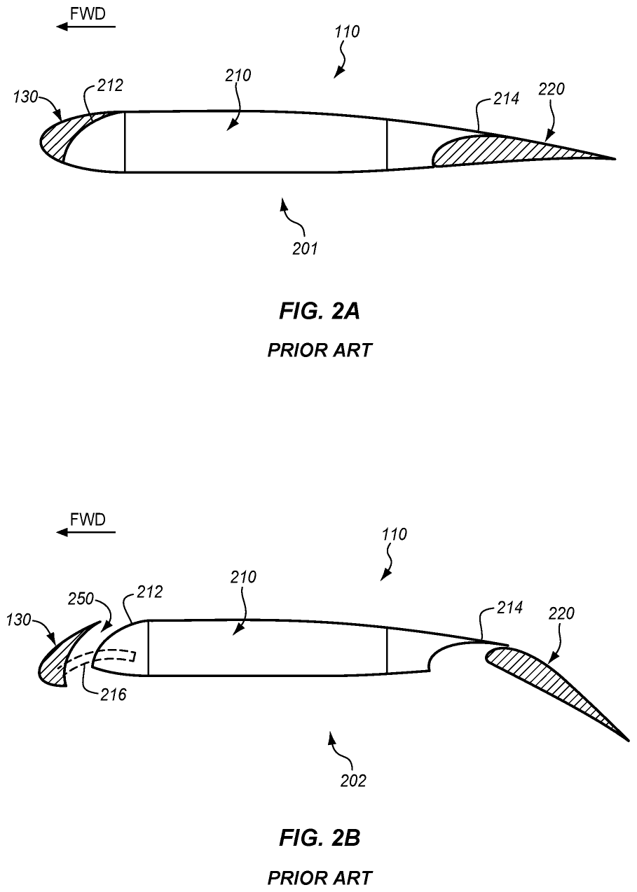

FIG. 2A is a side view of wing 110 in retracted position 201. FIG. 2B is a side view of wing 110 in deployed position 202. Generally, wing 110 is controlled to retracted position 201 during cruise of aircraft 100, and to deployed position 202 for takeoff and landing. Wing 110 includes one or more slats 130, main wing element 210, and one or more flaps 220.

Slat 130 is disposed along leading edge 212 of wing 110 and flap 220 is disposed along trailing edge 214 of wing 110. In retracted position 201, slat 130 and flap 220 are flush with leading edge 212 and trailing edge 214, respectively. In deployed position 202, slat 130 extends forward from leading edge 212 and flap 220 extends aft from trailing edge 214. Slat 130 is moved to position via guidance mechanism 216.

In deployed position 202, slat 130 changes the aerodynamic shape of wing 110 to increase lift. In particular, forward extension of slat 130 increases the camber of wing 110 and creates a gap 250 between slat 130 and leading edge 212. High pressure air flows from an underside of leading edge 212 through gap 250 and into the boundary layer air moving over the top of wing 110, adding energy and lift to wing 110 for takeoff and landing. Although the deployed position 202 of FIG. 2B shows slat 130 with gap 250, slat 130 may also be moved to deployed position 202 in which there is no gap between slat 130 and leading edge 212, typically representative of a takeoff configuration. This may be referred to as a sealed position wherein a trailing edge of slat 130 touches the surface of leading edge 212 of main wing element 210.

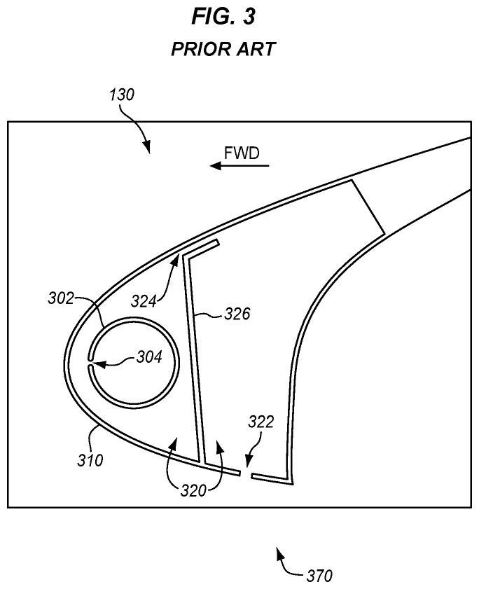

FIG. 3 is a cross-sectional side view of slat 130. It is generally known to provide an air duct 302 spanwise within slat 130 as part of a wing anti-ice feature. Air duct 302 transports hot air from an engine compressor to prevent the formation of frost and ice on skin structure 310 of the slat 130. As part of an outer wing surface, skin structure 310 has an aerodynamic shape that is beneficially preserved by the anti-ice system at times of cold temperatures and the presence of supercooled liquid water droplets in the external environment 370.

A hollow space 320, or internal area, within skin structure 310 temporarily contains the hot air before it exits into the external environment 370 via vent hole 322 on the underside of slat 130. After entering hollow space 320 via hole(s) 304 in air duct 302, hot air generally circulates around a leading edge, or front portion, of hollow space 320 and then travels through a passageway 324 between a nose beam 326 and skin structure 310 to an aft portion of hollow space 320 that includes vent hole 322. In current aircraft systems, the hot air of the wing anti-ice system has no additional benefit beyond its anti-ice function before it is exhausted out the bottom of slat 130 via vent hole 322 into the external environment 370.

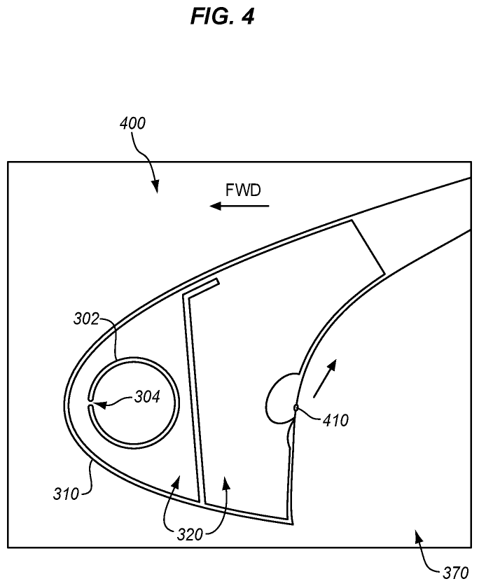

FIG. 4 is a cross-sectional side view of a slat 400 in an illustrative embodiment. Slat 400 is enhanced to include one or more nozzles 410 disposed on skin structure 310 to accelerate air collected in hollow space 320 into the external environment 370 outside slat 400 to increase lift and reduce drag for the wing. Advantageously, nozzle 410 may apply air from the anti-ice system of aircraft 100 (which would otherwise be wasted through vent hole 322 as discussed in FIG. 3) to increase the lift-to-drag ratio (L/D) for enhanced takeoff performance and stall capability. Increasing L/D of the wing during takeoff and climb-out portions of the flight improves the payload and range of aircraft 100. This provides an additional benefit of potentially enabling a reduction in the engine core size and engine rating, resulting in a lower weight of aircraft 100 which can lead to lower fuel consumption and reduced emissions. Additionally, slat 400 enhanced with nozzle 410 achieves increased L/D beyond the level achieved in current designs which are limited by the geometrical constraints of the wing. Variations of nozzle 410 location, orientation, and related benefits are discussed in further detail below.

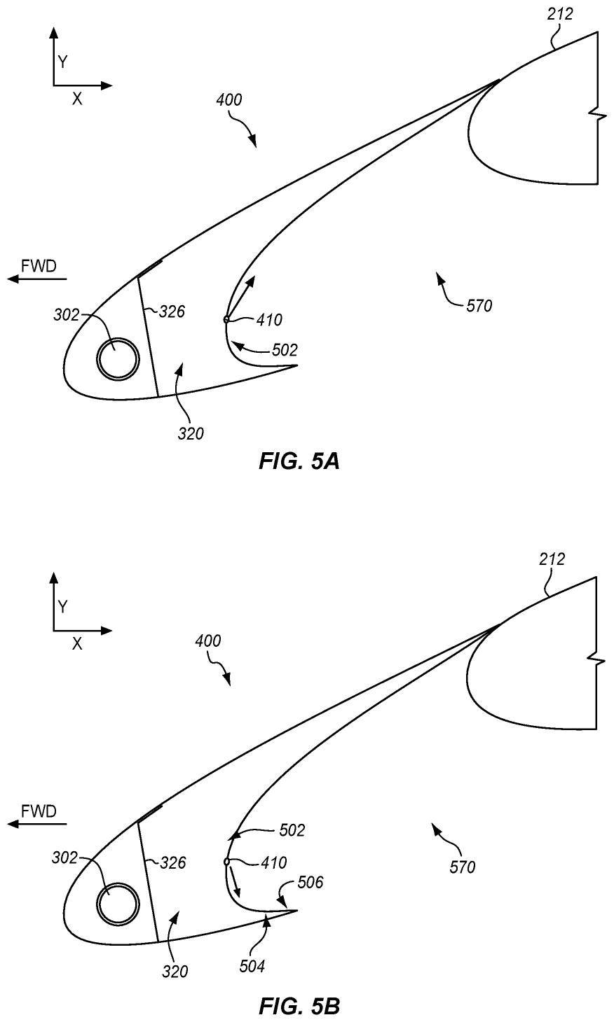

FIG. 5A is a cross-sectional side view of slat 400 with nozzle 410 at aft surface 502 of slat 400 in an illustrative embodiment. FIG. 5B is a cross-sectional side view of slat 400 with nozzle 410 at aft surface 502 of slat 400 in another illustrative embodiment. Aft surface 502 of slat 400 generally extends in a vertical direction (e.g., Y-direction) and faces leading edge 212 of wing 110 and abuts leading edge 212 when retracted. FIGS. 5A-B show slat 400 deployed forward, creating an open area, or cove region 570, between slat 400 and leading edge 212 of wing 110.

In FIG. 5A, nozzle 410 is disposed on the aft surface 502 of slat 400 and oriented upward and aft. Nozzle 410 is thus angled to eject air into cove region 570 in a first circular direction (e.g., counterclockwise direction). During flight, airflow naturally recirculates around the cove region 570 (e.g., in a clockwise direction), which is a source of aerodynamic drag. Therefore, nozzle 410 positioned at aft surface 502 and angled to jet air in a direction that is upward and aft (e.g., a positive 20 degrees relative to aft surface 502) such as in FIG. 5A is effective in countering recirculating flow within cove region 570 and reducing drag for wing 110.

By contrast, in FIG. 5B, nozzle 410 is disposed on the aft surface 502 of slat 400 and oriented downward and aft. Nozzle 410 is thus angled to eject air in a second circular direction (e.g., clockwise direction). However, here the airflow ejects along a lower lip 504 of slat 400 toward trailing edge 506. Lower lip 504 generally extends in a horizontal direction (e.g., X-direction) aft from aft surface 502 and terminates at trailing edge 506. Nozzle 410 positioned at aft surface 502 and angled in a direction that is downward and aft (e.g., a negative 20 degrees relative to aft surface 502) such as in FIG. 5B is effective in energizing the wake turbulence off of trailing edge 506 of slat 400 which also helps to counter recirculating airflow within cove region 570 to reduce drag for wing 110.

Slat 400 may therefore be enhanced with one or more nozzles 410 oriented on aft surface 502 in a direction upward/aft and/or downward/aft to improve flight performance. Nozzle 410 may comprise any device to control the direction of a fluid and/or increase its velocity as it passes through its body. Examples of type of nozzle 410 include a convergent nozzle or a convergent/divergent nozzle. In one embodiment, nozzle 410 comprises a passive nozzle wherein pressure differential between the internal area, or hollow space 320, of slat 400 and the external environment, or cove region 570, causes the air to be ejected through nozzle 410. In another embodiment, an absolute value of the angle of nozzle 410 relative to aft surface 502 is in a range between ten degrees and thirty degrees. Although nozzle 410 is shown protruding from slat 400 for illustration purposes, it will be appreciated that nozzle 410 may be defined by the two lobe surfaces within slat 400 having a convergent passage to accelerate the flow and that the nozzle exit may be flush with the slat surface so as not to inhibit stowing. In some embodiments, slat 400 includes a plurality of nozzles 410 arranged or spaced along its length in a spanwise direction.

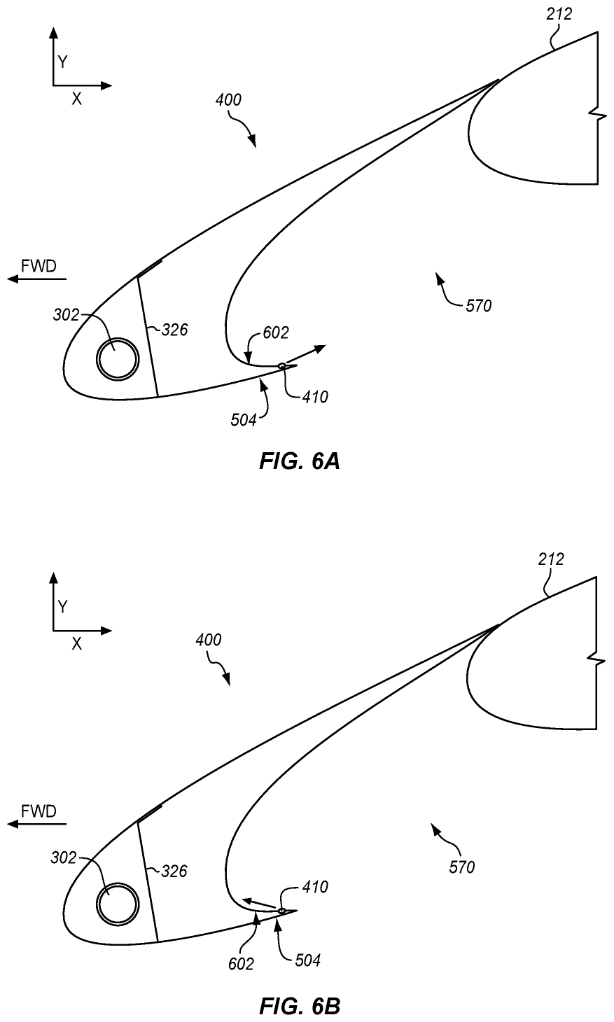

FIG. 6A is a cross-sectional side view of slat 400 with nozzle 410 at lower lip 504 in an illustrative embodiment. FIG. 6B is a cross-sectional side view of slat 400 with nozzle 410 at lower lip 504 in another illustrative embodiment. In FIGS. 6A-6B, nozzle 410 is disposed on upper surface 602 of lower lip 504 of slat 400. In FIG. 6A, nozzle 410 is angled to eject in a direction that is upward and aft (e.g., a negative 20 degrees relative to upper surface 602) to energize the wake from slat 400. In FIG. 6B, nozzle 410 is angled to eject in a direction that is upward and forward (e.g., a positive 20 degrees relative to upper surface 602) to suppress recirculation in the cove region 570. In one embodiment, an absolute value of the angle of nozzle 410 relative to upper surface 602 is in a range between ten degrees and thirty degrees.

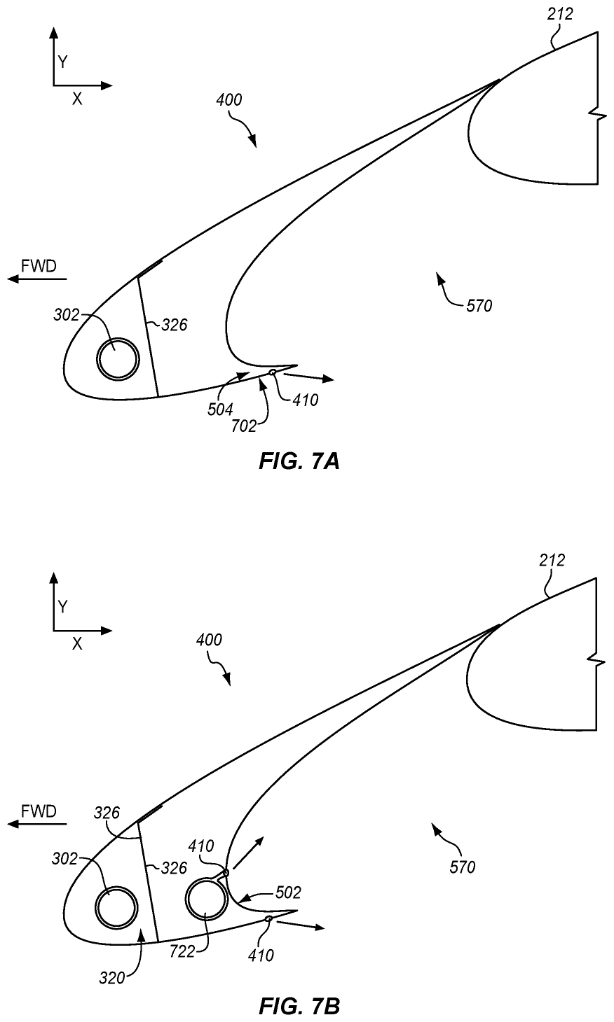

FIG. 7A is a cross-sectional side view of slat 400 with nozzle 410 at lower lip 504 in yet another illustrative embodiment. In FIG. 7A, nozzle 410 is disposed on lower surface 702, or underside, of lower lip 504 of slat 400 and is pointed in the general downstream direction. In one embodiment, the axis of nozzle 410 is oriented to eject air downward and aft to form an angle of approximately thirty degrees with lower surface 702. In general, the relatively lower pressure of the ambient flow at lower surface 702 helps accelerate the flow and expel the high-pressure air of air duct 302 through the body of nozzle 410. Such underside application is also effective in impacting flow structure with cove region 570 to increase lift and reduce drag.

FIG. 7B is a cross-sectional side view of slat 400 with multiple air ejection sources in an illustrative embodiment. As shown in this example, slat 400 includes one or more nozzles 410 on lower surface 702 of lower lip 504 and further includes one or more nozzles 410 on aft surface 502 to eject air into cove region 570. Moreover, in addition to air duct 302, slat 400 further includes a second air duct 722 configured to receive/transport air from a second air supply source (not shown) of the aircraft. For example, air duct 302 may transport air to slat 400 from a Wing Anti-Ice (WAI) system of the aircraft which is ejected out of nozzle 410, and second air duct 722 may transport air to slat 400 from an Auxiliary Power Unit (APU), excess available engine bleed, from a separate compressor, or redirected air from the Engine Anti-Ice (EAI) system of the aircraft which is ejected out of a different nozzle 410.

Nozzle 410 on lower surface 702 ejects air from hollow space 320 and air duct 302, whereas nozzle 410 on aft surface 502 ejects air from second air duct 722. Larger gains in L/D may be realized by combining multiple different nozzle locations/orientations on slat 400 with respective multiple air sources. In one embodiment, air duct 302 extends spanwise within slat 400 along a front portion of hollow space 320 (e.g., forward from nose beam 326) and second air duct 722 extends spanwise within slat 400 along a back portion of hollow space 320 (e.g., aft of nose beam 326). One or more nozzles 410 on aft surface 502 may couple with second air duct 722. In a further embodiment, nozzles 410 on aft surface 502 and lower surface 702 may alternate with one another in a spanwise direction of slat 400. Nozzles 410 of different surfaces of slat 400 which are installed in alternating fashion at selected span segments may provide a wider area coverage for increased lift and reduced drag for the wing.

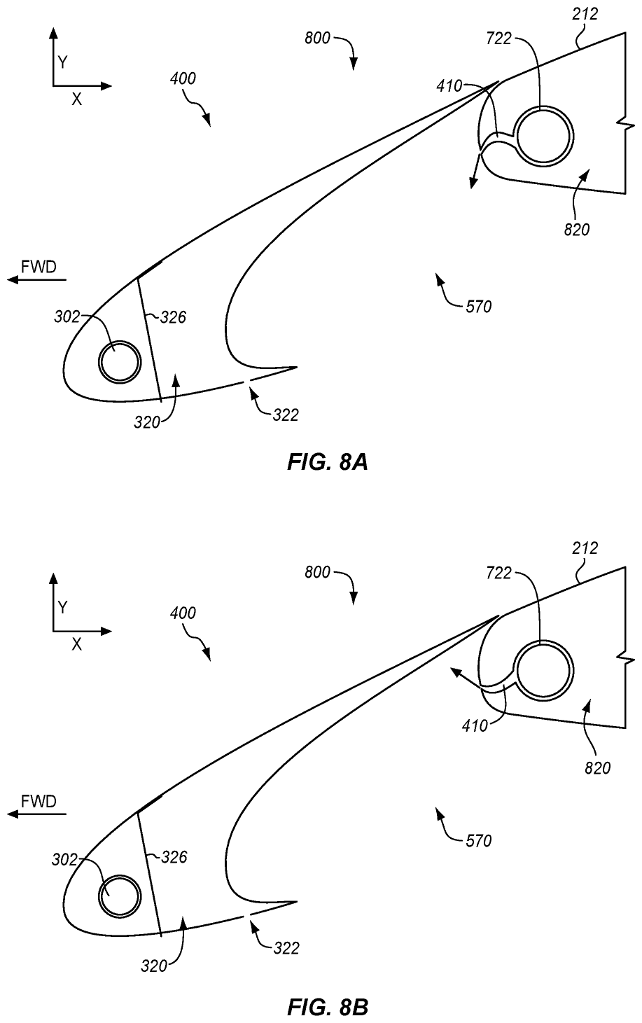

FIG. 8A is a cross-sectional side view of a wing leading edge 800 in an illustrative embodiment. FIG. 8B is a cross-sectional side view of wing leading edge 800 in another illustrative embodiment. In FIGS. 8A-8B, one of the multiple air ejection sources is in the main wing element. In particular, second air duct 722 may be disposed spanwise along a hollow space 820 of leading edge 212 of the main wing element. Second air duct 722 and associated nozzle(s) 410 may be used in combination with air duct 302 and nozzles of slat 400 (nozzles of slat 400 not shown in FIGS. 8A-8B, though any combination of previous nozzle arrangements are possible) to improve aerodynamic performance and potentially offer an advantage in terms of system integration.

In FIG. 8A, one or more nozzles 410 are coupled with second air duct 722 and oriented to eject air from leading edge 212 in a downward and aft direction into cove region 570. In FIG. 8B, by contrast, one or more nozzles 410 of second air duct 722 eject air from leading edge 212 in an upward and forward direction into cove region 570. In FIGS. 8A-8B, nozzle 410 circulates air around cove region 570 to provide similar advantages as previously described in countering recirculating flow within cove region 570 to increase lift and reduce drag for the aircraft.

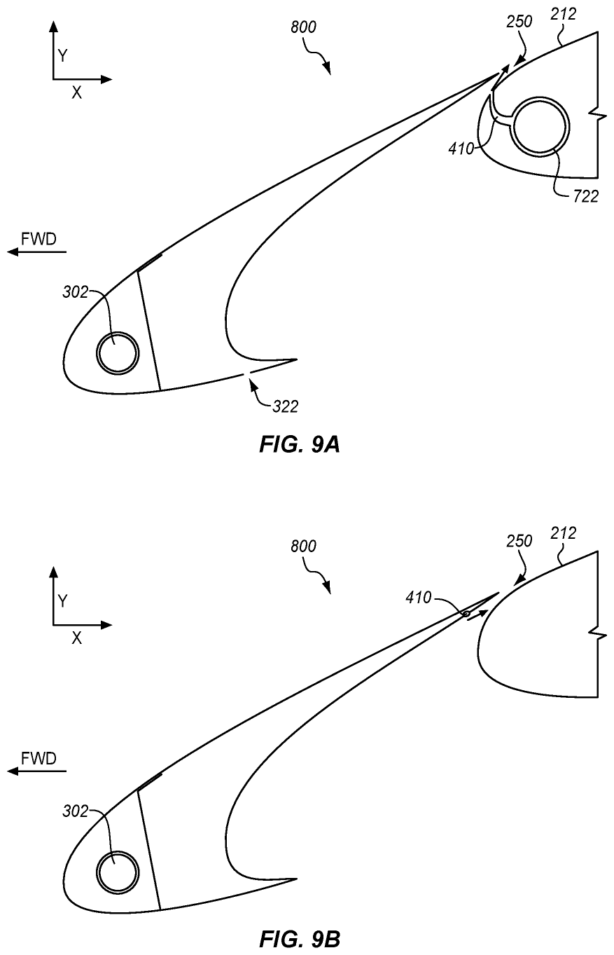

FIG. 9A is a cross-sectional side view of wing leading edge 800 in a further illustrative embodiment. FIG. 9B is a cross-sectional side view of wing leading edge 800 in yet a further illustrative embodiment. In FIGS. 9A-9B, forward extension of slat 130 creates gap 250 between slat 130 and leading edge 212, and one or more nozzles 410 are situated to inject air into gap 250 to energize the viscous layer along the top of the wing and improve aerodynamic performance. In particular, in FIG. 9A, nozzle 410 at leading edge 212 is angled to eject air into gap 250. Similarly, in FIG. 9B, nozzle 410 at slat 400 is angled to eject air into gap 250. Nozzle 410 may be situated proximate to gap 250, and may use air from air duct 302 and/or second air duct 722 as described previously.

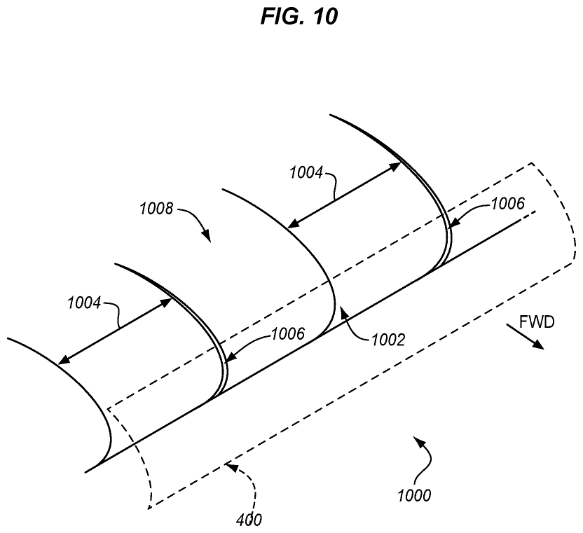

FIG. 10 is a perspective view of a wing leading edge 1000 in an illustrative embodiment. Wing leading edge 1000 includes a wing under slat surface 1002 that is generally covered by slat 400 (not shown) when slat 400 is in retracted position 201 and exposed to external environment 370 when slat 400 is in deployed position 202. Wing under slat surface 1002 includes alternate span segments 1004 that incorporate shallow indentations 1006 for improved aerodynamic performance.

Indentations 1006 extend forward and aft along an upper surface 1008 of wing leading edge 1000. In particular, the depth of indentation 1006 narrows as indentation 1006 extends backward in an aft direction. Indentations 1006 thus form gaps or openings (e.g., similar to gaps 250 in FIG. 9) that accelerate air flow along upper surface 1008 of wing leading edge 1000 for improved aerodynamic performance. As earlier suggested, indentations 1006 may be covered by slat 400 when slat 400 is stowed against wing leading edge 1000 such that cruise mold lines are unaffected, and exposed when slat 400 is deployed forward. Indentations 1006 may be combined with earlier described embodiments, including the gapped configuration in which nozzle(s) 410 inject air flow into gap 250 to energize airflow along indentations 1006 and increase lift for the wing. Alternatively or additionally, indentations 1006 may be applied on a lower surface of slat 400 for improved aerodynamic performance.

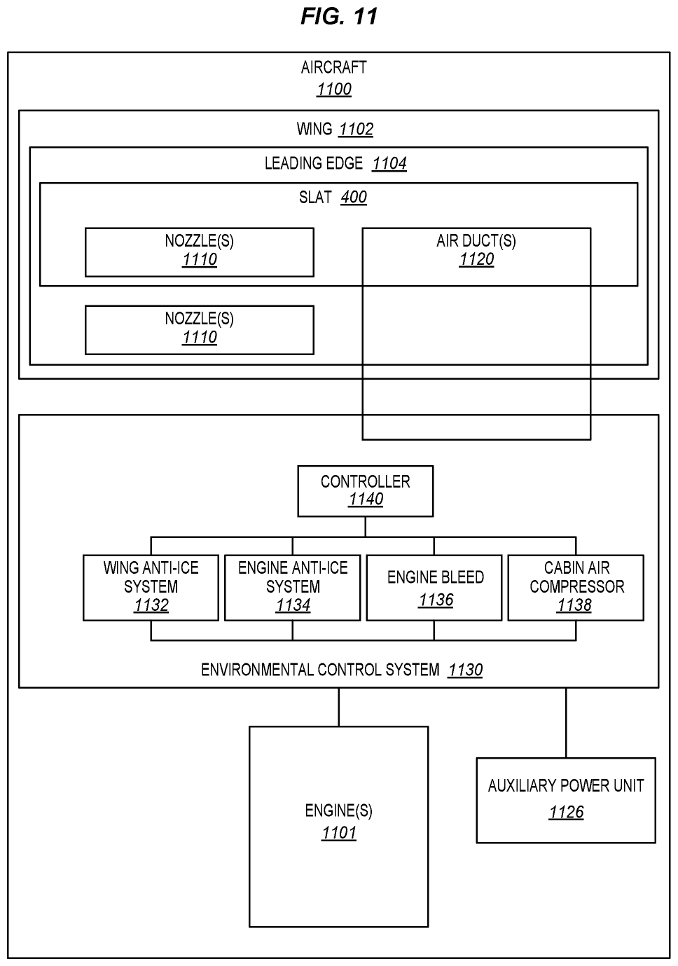

FIG. 11 is a block diagram of aircraft 1100 in an illustrative embodiment. Aircraft 1100 may comprise a commercial aircraft as shown in FIG. 1, or another type of aircraft that uses nozzle acceleration at its wing leading edge. Aircraft 1100 may include numerous components that are not shown or described for the sake of brevity. In this embodiment, aircraft 1100 includes one or more engines 1101 and wings 1102. Engines 1101 provide thrust for aircraft 1100, and may comprise combustion engines (e.g., jet engines), electric engines, and/or hybrid electric engines.

Leading edge 1104 of wing 1102 includes one or more slats 400, such as that shown in FIGS. 4-9. Each slat 400 may include one or multiple nozzles 1110. Alternatively or additionally, a portion of leading edge 1104 of wing 1102 other than slat 400 may include one or multiple nozzles 1110. Nozzles 1110 may receive air via one or more air ducts 1120 extending through leading edge 1104 and/or slat 400. Air duct 1120 may transport air generated from engine 1101 or an auxiliary power unit 1126 of aircraft 1100. More particularly, air duct 1120 may comprise a component of or couple with a component of an environmental control system 1130 of aircraft 1100. Air sources of environmental control system 1130 include wing anti-ice system 1132, engine anti-ice system 1134, engine bleed 1136, and cabin air compressor 1138.

Transportation of air throughout aircraft 1100 may be selectively controlled by controller 1140. Controller 1140 is implemented on a hardware platform comprised of analog circuitry, digital circuitry, and/or a processor that executes instructions stored in memory. A processor comprises an integrated hardware circuit configured to execute instructions, and a memory is a non-transitory computer readable storage medium for data, instructions, applications, etc., and is accessible by the processor. In one embodiment, controller 1140 is configured to actuate valves to control airflow through air duct 1120 and or nozzles 1110. In some embodiments, each subsystem of environmental control system 1130 includes its own controller for air control, and controller 1140 coordinates the different air supply sources to control the flow to the active flow control ducting and nozzle.

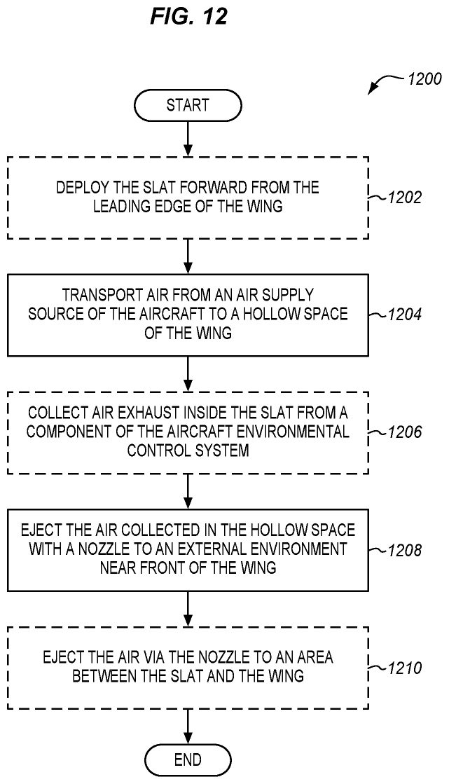

FIG. 12 is a flow chart illustrating a method 1200 of improving aerodynamic airflow for an aircraft in an illustrative embodiment. The steps of method 1200 will be described with respect to aircraft 1100 of FIG. 11, although one skilled in the art will understand that the methods described herein may be performed on other types of aircraft. The steps of the methods described herein are not all inclusive and may include other steps not shown. The steps for the flow charts shown herein may also be performed in an alternative order.

In optional step 1202, slat 400 is deployed forward from leading edge 1104 of wing 1102. In one embodiment, slat 400 is deployed forward to a sealed position at takeoff and in a gapped, or slotted, position at landing. A gapped position at landing may create a wide or large gap between leading edge 1104 and slat 400. In some embodiments, slat 400 is deployed to sealed position with no gap or alternatively with a small gap for takeoff. Thus, in general, slat 400 may be deployed forward from leading edge 1104 of wing 1102 to create a gap (e.g., gap 250) between slat 400 and leading edge 1104.

In step 1204, an air supply source of the aircraft (e.g., auxiliary power unit 1126, wing anti-ice system 1132, engine anti-ice system 1134, engine bleed 1136, or cabin air compressor 1138) transports air to a hollow space (e.g., hollow space 320/820 and/or air duct 302/722) of wing 1102. In some embodiments, controller 1140 may initiate air actuation based on input from pilot or automatically with deployment of slat 400 or a particular portion of flight such as takeoff. In optional step 1206, slat 400 collects air exhaust from a component of environmental control system 1130. For example, an air vent along bottom of slat 400 may be sealed or removed such that air from wing anti-ice system 1132 collects in hollow space 320 of slat 400.

In step 1208, the air collected in the hollow space of wing 1102 is ejected into the external environment 370 near the front of wing 1102. In optional step 1210, nozzle 410 ejects the air between slat 400 and wing 1102. In one embodiment, nozzle 410 ejects the air through the gap 250. Accordingly, aerodynamic airflow for aircraft 1100 is improved by injecting air at leading edge 1104 that is generated from an existing aircraft system and which may otherwise have gone to waste.

Although specific embodiments were described herein, the scope is not limited to those specific embodiments. Rather, the scope is defined by the following claims and any equivalents thereof.

1. A slat disposed along a leading edge of a wing of an aircraft, the slat comprising:
a skin structure having an aerodynamic shape;
a hollow space within the skin structure; and
a nozzle disposed on the skin structure to accelerate air collected in the hollow space into an external environment outside the slat to increase lift and reduce drag for the wing.

2. The slat of claim 1 wherein:
the nozzle is disposed on an aft surface of the slat and oriented to eject the air into a cove region between the slat and the wing.

3. The slat of claim 2 wherein:
the nozzle is angled upward to eject the air to counter recirculating airflow in the cove region and reduce drag for the wing.

4. The slat of claim 2 wherein:
the nozzle is angled to eject the air through a gap between the slat and the wing to energize airflow along an upper surface of the wing and increase lift for the wing.

5. The slat of claim 2 wherein:
the nozzle is angled downward to eject the air in a circular direction in the cove to energize a wake turbulence off a trailing edge of the slat and reduce drag for the wing.

6. The slat of claim 2 wherein:
the nozzle is oriented at an angle relative to the aft surface of the slat, and an absolute value of the angle is in a range between ten degrees and thirty degrees.

7. The slat of claim 1 wherein:
the nozzle is disposed on a lower lip of the slat and oriented to eject the air into a cove region between the slat and the wing.

8. The slat of claim 1 wherein:
the nozzle is disposed on an underside surface of the slat and oriented to eject the air in an aft direction.

9. The slat of claim 1 further comprising:
an air duct to transport air from an air supply source of the aircraft to the hollow space, wherein the air supply source is one of a wing anti-ice system, an auxiliary power unit, an engine anti-ice system, an engine bleed, and a cabin air compressor.

10. The slat of claim 1 further comprising:
a pair of air ducts including a first air duct to transport air from a first air supply source to the hollow space, and a second air duct to receive air from a second air supply source of the aircraft;
a first nozzle disposed on an underside surface of the slat and oriented to eject the air collected in the hollow space into the external environment in an aft direction; and
a second nozzle disposed on an aft surface of the slat to eject the air collected in the second air duct into a cove region between the slat and the wing.

11. The slat of claim 1 further comprising:
a plurality of nozzles spaced from each other in a spanwise direction along the slat, the plurality of nozzles each configured to eject the air from the hollow space into the external environment.

12. An aircraft comprising:
a wing including a leading edge; and
a slat mounted at the leading edge of the wing,
wherein at least one of the wing and the slat includes a nozzle to accelerate air collected inside the at least one of the wing and the slat to an external environment of the aircraft to increase lift and reduce drag for the wing.

13. The aircraft of claim 12 further comprising:
a wing anti-ice system to heat the slat via an air duct disposed in a spanwise direction in a hollow space of the slat,
wherein the air duct transports air exhaust of the wing anti-ice system into the hollow space, and
wherein the nozzle is disposed on the slat to accelerate the air exhaust of the wing anti-ice system into the external environment.

14. The aircraft of claim 12 further comprising:
an air supply source to supply air to the wing via an air duct disposed in a spanwise direction of the wing,
wherein the nozzle is disposed on the wing to accelerate the air in the air duct from the leading edge of the wing forward into a cove region between the wing and the slat.

15. The aircraft of claim 12 further comprising:
a first air supply source to supply air to the slat via a first air duct in the slat;
a second air supply source to supply air to the wing via a second air duct disposed in the wing;
a first nozzle disposed on the slat to eject the air collected in the slat into a cove region between the slat and the wing; and
a second nozzle disposed on the wing to eject the air collected in the wing in the cove region between the slat and the wing.

16. The aircraft of claim 15 wherein:
the wing includes one or more indentations extending forward and aft along an upper surface of the leading edge of the wing, the one or more indentations being covered by the slat when the slat is stowed against the wing and being exposed when the slat is deployed forward from the wing, and
the first nozzle and the second nozzle have respective orientations to accelerate air through a gap between the slat and the wing to energize airflow along the one or more indentations and increase lift for the wing.

17. A method of improving aerodynamic airflow for a wing of an aircraft, the method comprising:
transporting air from an air supply source of the aircraft to a hollow space within a slat of the wing; and
ejecting the air collected in the hollow space with a nozzle to an external environment in front of a leading edge of the wing.

18. The method of claim 17 wherein the method further comprises:
deploying the slat forward from the leading edge of the wing to create a gap between the slat and the wing; and
ejecting the air via the nozzle through the gap between the slat and the wing.

19. The method of claim 17 wherein transporting the air from the air supply source to the hollow space comprises:
collecting air exhaust in the hollow space from a wing anti-ice system of the aircraft.

20. The method of claim 19 wherein the method further comprises:
ejecting the air exhaust of the anti-ice system from the hollow space of the slat to a cove region between the slat and the wing.
